(19) United States
(12) Patent Application Publication
(10) Pub. No.: US 2015/0253918 A1
(43) Pub. Date: Sep. 10, 2015

(54) 3D Multi-Touch

(71) Applicant: Cherif Algreatly, Newark, CA (US)

(72) Inventor: Cherif Algreatly, Newark, CA (US)

(21) Appl. No.: 14/201,847

(22) Filed: Mar. 8, 2014

(51) Int. Cl. G06F 3/041; G06F 3/0354; G06F 3/0488

(52) U.S. Cl. CPC G06F 3/0414; G06F 3/04886; G06F 3/03545; G06F 2203/04101; G06F 2203/04104

(57) ABSTRACT

A computer input method for recognizing the 3D direction of a single or multiple objects simultaneously touching a surface is disclosed. Detection of the 3D direction provides an immediate input to the computer system representing typing, triggering shortcuts, or activating predefined commands on the computer display. The object can be a finger, stylus, or pen. The surface can be touchscreen or case of a mobile phone, tablet, computer, GPS, or the like. The method enables the user to interact with electronic devices without having to maintain sight of the device display during interaction.

### CROSS-REFERENCE TO RELATED APPLICATION

None.

### BACKGROUND

Multi-touch refers to the ability of a touch surface, such as a touchscreen or touchpad, to recognize the presence of more than one point of touch. It is usually used to implement advanced functionality to activate certain sub routines associated with predefined gestures. The concept of multi-touch is based on tracking the simultaneous movement of a plurality of fingers on a surface. The tracking includes the number of the fingers and the movement of the fingers relative to each other, or relative to the x and y-axis of the surface plane. This type of tracking limits the number of the multi-touch alternatives that can be generated by fingers, where the fingers movement is constrained by a two-dimensional surface or space.

The addition of a third dimension to the multi-touch can increase the number of the intuitive multi-touch alternatives generated by a user which improves the user's productivity. Moreover, creating a new type of 3D multi-touch can open the door for new computer and mobile phone applications, especially with the increased availability of the modern touchscreens technology that detects more information than the points of touch. For example, the U.S. patent Ser. No. 12/587,339, which is assigned to the assignee of the present patent application, discloses a new touch sensing technology capable of detecting the 3D directions and the magnitudes of multiple touch forces simultaneously applied to a surface. Utilizing the 3D direction and the magnitude of the force applied by a finger to the touchscreen can create this new type of 3D multi-touch. This 3D multi-touch can be more intuitive to use and more productive to utilize than the traditional two-dimensional multi-touch.

### SUMMARY

The present invention discloses a new method of 3D multi-touch that can be used with a mobile phone, tablet, or computer touchscreen to increase the user's productivity. For example, with one touch of a finger or multiple fingers to a touchscreen or touchpad, an enormous number of 3D multi-touch can be created. Each one of the 3D multi-touch is interpreted as a unique input to activate a predefined command on the computer display. This is done without the user's need to move his/her finger from the original touch point on the touchscreen or touchpad. The 3D multi-touch can also be activated when touching one or two buttons on a computer mouse, or one or more keys of a computer keyboard. This empowers traditional computer input devices to achieve new functions which dramatically increase the user's productivity. Moreover, the present invention enables a user to type with a single finger on a touchscreen without needing to observe the touchscreen while walking or laying supine. Also, the present invention enables a car driver to easily interact with a GPS, Radio, or a car device while driving without the user having to look away from the road.

Generally, in one embodiment, the present invention discloses a method for 3D multi-touch comprising: applying multi-touch forces to a surface wherein the multi-touch forces can be non-parallel and non-orthogonal to the surface plane; determining the three-dimensional direction of each force of the multi-touch forces; and interpreting each unique combination of three-dimensional directions as a unique input to be provided to a computer system.

In another embodiment, the present invention discloses a method for 3D touch comprising: applying a single touch force to a surface wherein the single touch force can be non-parallel and non-orthogonal to the surface plane; determining the three-dimensional direction and the magnitude of the single touch force; and interpreting each unique combination of a three-dimensional direction and a magnitude as a unique input to be provided to a computer system.

In another embodiment, the present invention discloses a method for 3D multi-touch comprising: applying multi-touch forces to a surface wherein the multi-touch forces are parallel to the surface plane; determining the direction of each force of the multi-touch forces; and interpreting each unique combination of directions of the multi-touch forces as a unique input to be provided to a computer system.

In another embodiment, the present invention discloses a method for 3D multi-touch comprising: applying multi-touch forces to a surface wherein one or more forces of the multi-touch forces are non-parallel to the surface plane; and the other forces of the multi-touch forces are parallel to the surface plane; determining the direction of each force of the multi-touch forces; and interpreting each unique combination of directions as a unique input to be provided to a computer system.

In all of the aforementioned methods, the surface can be a touchscreen of a mobile phone, tablet, or computer, or a touchpad of a laptop or electronic device. It can also be the left button or the right button of a computer mouse, or one or more keys of a computer keyboard. The multi-touch can be created by one or more fingers of a single hand, or can be created by multiple fingers of the left and right hands. Each unique input provided to the computer system represents invoking a program command to perform a certain action on the computer display, similar to the functions of MICROSOFT OFFICE keyboard shortcuts, GOOGLE CROME keyboard shortcuts, and the like.

Overall, the above Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1 to 3 illustrate a finger applying touch forces to a surface in different 3D directions.

FIG. 4 illustrates representing the 3D direction of a force applied to a surface, by a first angle located between the 3D direction and the surface plane, and a second angle located between the projection of the 3D direction on the surface and the x-axis of the surface plane.

FIGS. 5 to 7 illustrate two fingers simultaneously applying two touch forces to a surface.

FIG. 8 is a table indicating four combinations of 3D directions of two touch forces applied by two fingers to a surface.

FIGS. 9 to 11 illustrate utilizing the present invention with a touchscreen of a computer, tablet, and mobile phone.

FIG. 12 illustrates utilizing the present invention with the left and right buttons of a computer mouse.

FIG. 13 illustrates utilizing the present invention with two keys of a computer keyboard.

FIG. 14 illustrates ten spots to be touched by a single finger, where each touch to a different spot applies a different 3D direction of a force.

FIGS. 15 and 16 illustrate using the present invention with a mobile phone without the need to touch the mobile phone screen on the user's part.

FIG. 17 illustrates holding a tablet with a hand while using the present invention by a finger of the same hand.

FIG. 18 illustrates using the present invention with a stylus that touches a tablet touchscreen.

FIG. 19 illustrates twenty five imaginary spots to be touched by a stylus or pencil to provide an immediate input to a computer system.

FIG. 20 illustrates using the present invention with a pencil equipped with a 3D force sensor.

FIG. 21 illustrates using the present invention with a touchscreen of a GPS or Radio while driving a car.

FIG. 22 illustrates using the present invention with a tablet to interact with a 3D computer application presented on the tablet screen.

FIGS. 23 and 24 illustrate two fingers touching a touchscreen to simultaneously apply two forces parallel to the touchscreen surface.

FIGS. 25 and 26 illustrate two fingers touching a touchscreen of a mobile phone to simultaneously apply two forces parallel to the touchscreen plane.

FIG. 27 illustrates a picture of a hand indicating the 3D direction of each finger of the hand.

### DETAILED DESCRIPTION

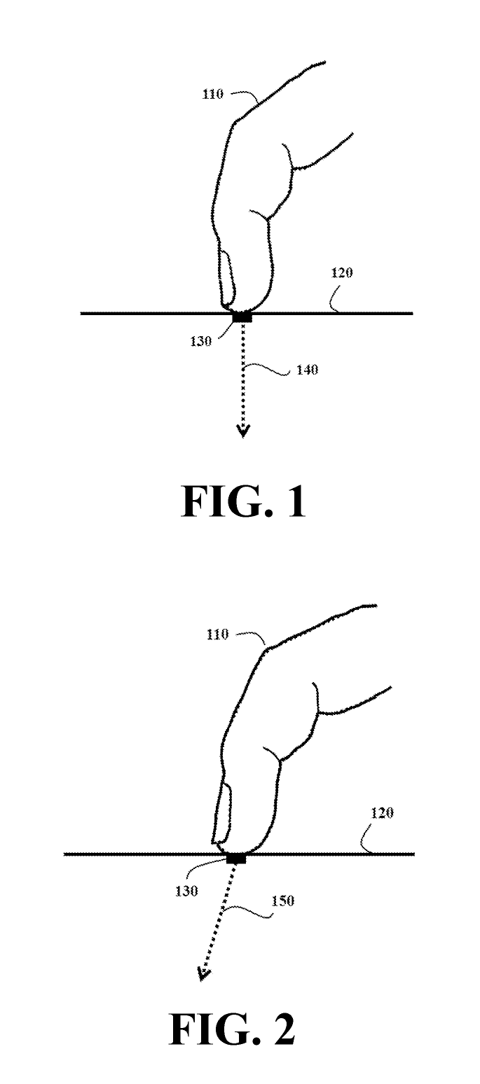

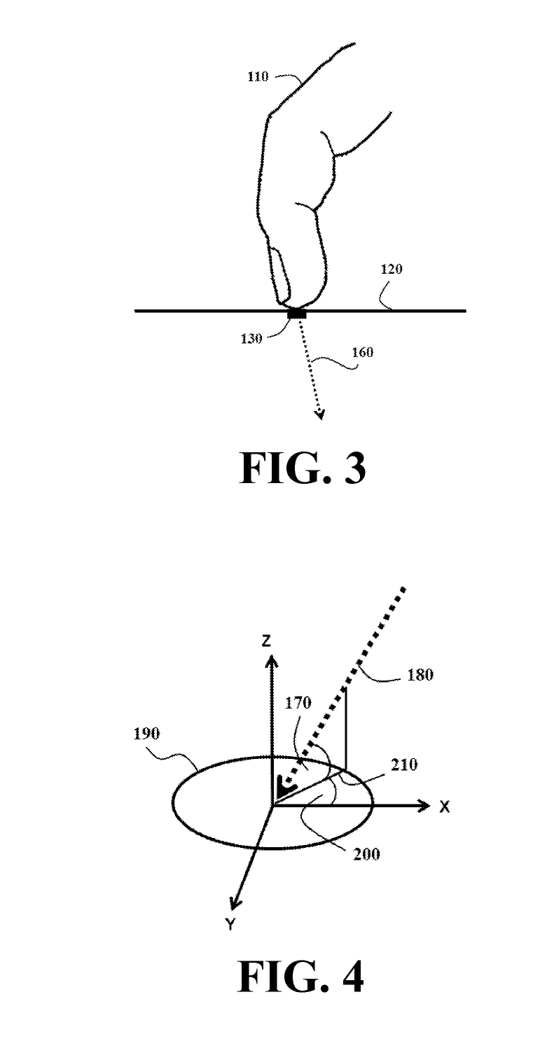

FIG. 1 illustrates a finger 110 touching a surface 120 at a point 130 where a force 140 orthogonally applied by the finger to the surface. FIG. 2 illustrates the same finger 110 touching the surface 120 at the same point 130 where the force 150 applied to the surface is non-orthogonal and non-parallel to the surface plane. FIG. 3 illustrates tilting the finger to apply a force 160 to the surface, where the angle located between the force and the surface is also non-orthogonal and non-parallel to the surface plane. FIG. 4 illustrates the way of representing the 3D direction of the force by a first angle and a second angle. The first angle 170 is located between a line 180 representing the force and the surface plane 190. The second angle 200 is located between the projection 210 of the line on the surface and the x-axis of the surface plane.

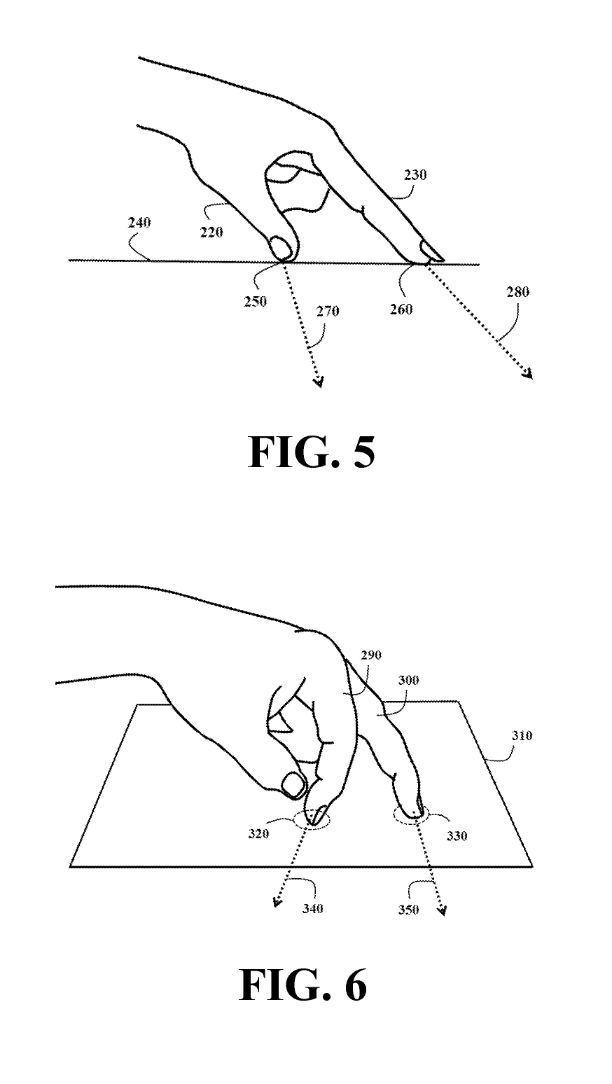

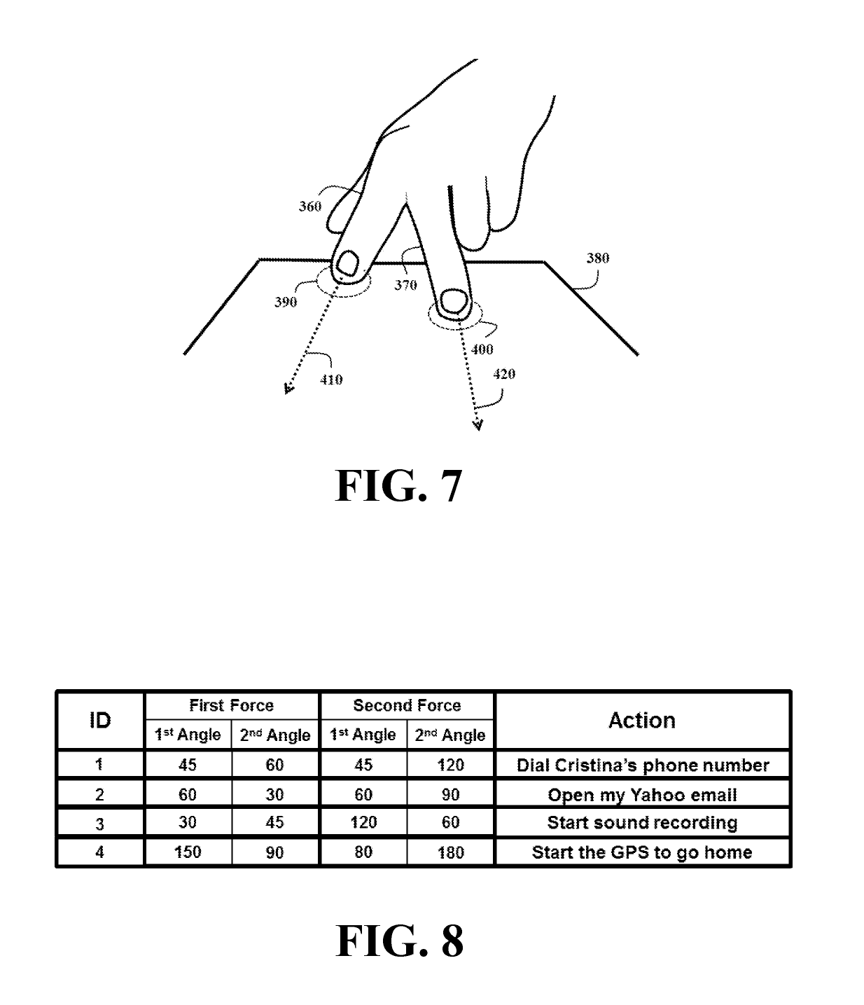

FIG. 5 illustrates a first finger 220 and a second finger 230 simultaneously touching a surface 240 at a first point 250 and a second point 260. The first finger applies a first force 270 to the surface, and the second force applies a second force 280 to the surface. The first force has a first 3D direction relative to the surface plane, and the second force has a second 3D direction relative to the surface plane. FIG. 6 illustrates a first finger 290 and a second finger 300 simultaneously touching a surface 310 at a first point 320 and a second point 330. The first force applies a first force 340 in a first 3D direction relative to the surface plane, and the second force applies a second force 350 in a second 3D direction relative to the surface plane. FIG. 7 illustrates two fingers 360 and 370 simultaneously touching a surface 380 at a first point 390 and a second point 400, to apply a first force 410 and a second force 420 to the surface. The first and second forces of the previous three examples are non-orthogonal and non-parallel to the surface plane. Generally, the detected data of the 3D direction of the first force and the 3D direction of the second force can be utilized in various computer applications.

For example, in one embodiment, the present invention discloses a method for 3D multi-touch comprising: applying multi-touch forces to a surface wherein the multi-touch forces can be non-parallel and non-orthogonal to the surface plane; determining the three-dimensional direction of each force of the multi-touch forces; and interpreting each unique combination of three-dimensional directions as a unique input to be provided to a computer system.

The multi-touch forces can be generated by two or more fingers that are simultaneously touching the surface. The two or more fingers can be fingers of a single hand, or can be fingers of two hands. The 3D direction of each force of the multi-touch forces can be represented by a first angle and a second angle as previously described in FIG. 4. Each unique combination of 3D directions of two or more touch forces can be associated with a unique ID to be provided to a computer system. The computer system interprets each unique ID into a certain command or action to be performed on the computer screen. A list of actions or commands each of which is associated with a unique ID can be customized by a user according to his/her needs or preference.

FIG. 8 illustrates a table which presents four alternatives of two forces simultaneously applied to a mobile phone touchscreen. As shown in the table, the combination of the first and second angles of the first force, and the first and second angles of the second force is different in each case. Each different combination is assigned to a unique ID, from 1 to 4, and each unique ID is associated with an action or command. For example, the first combination can represent a command to dial a phone number from the user's contacts list. The second combination can represent a command to open the user's personal email. The third combination can represent a command to activate recording sound using the mobile phone. The fourth combination can represent a command to open the GPS application on the mobile phone screen, and create a route to the user's home. These are simply examples, which show that the user can individualize the action or command associated with each ID or create new or more even combinations. Creating new combinations is achieved by touching the mobile phone touchscreen with fingers and saving the configuration or parameters of each touch in association with an action or command. Once the fingers touch the touchscreen again in the same way, the action is performed on the mobile phone.

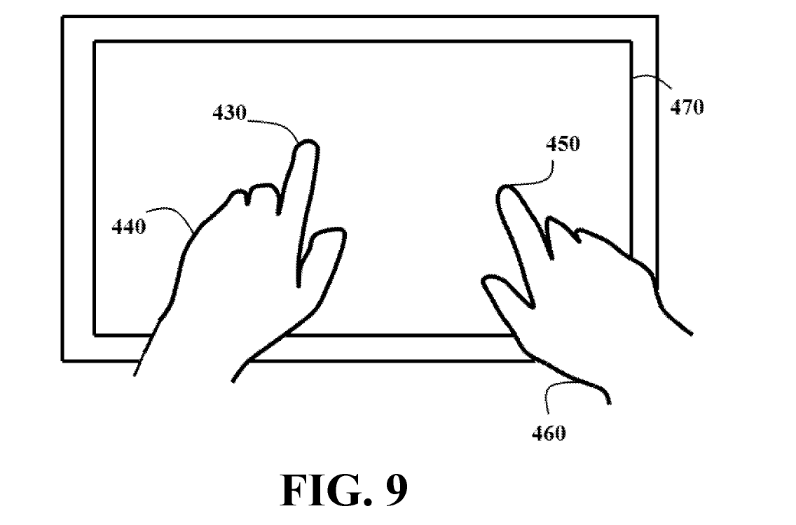

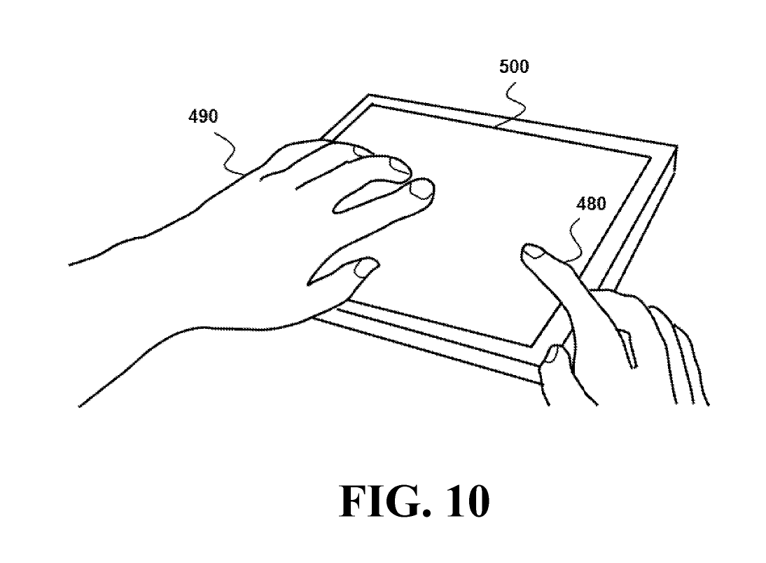

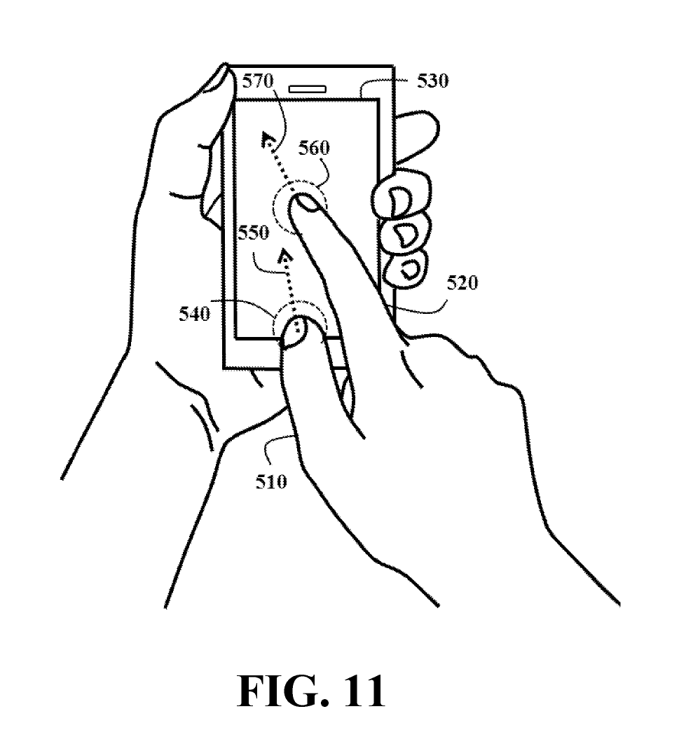

As mentioned previously, the present invention can be utilized with the touchscreen of a computer, tablet, or mobile phone. For example, FIG. 9 illustrates the index finger 430 of the left hand 440, and the index finger 450 of the right hand 460 simultaneously touching a computer touchscreen to provide an immediate input to the computer system activating a predefined command. FIG. 10 illustrates the index finger 480 of the right hands and the five fingers of the left hand 490 simultaneously touching a tablet touchscreen 500 to provide an immediate input activating a predefined command to the computer system of the tablet. FIG. 11 illustrates the thumb 510 and the index finger 520 of the right hand simultaneously touching a mobile phone touchscreen 530. The thumb touches the touchscreen at a first point 540 to apply a force 550 in a certain 3D direction. The index finger touches the touchscreen at a second point 560 to apply a force 570 in a certain 3D direction. Touching the touchscreen in this manner provides an immediate input to the computer system of the mobile phone activating a predefined command, as was described previously.

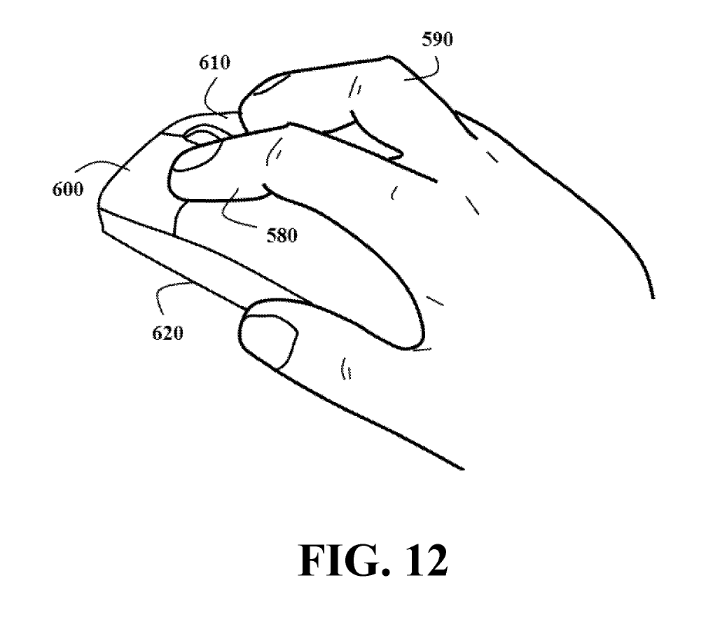

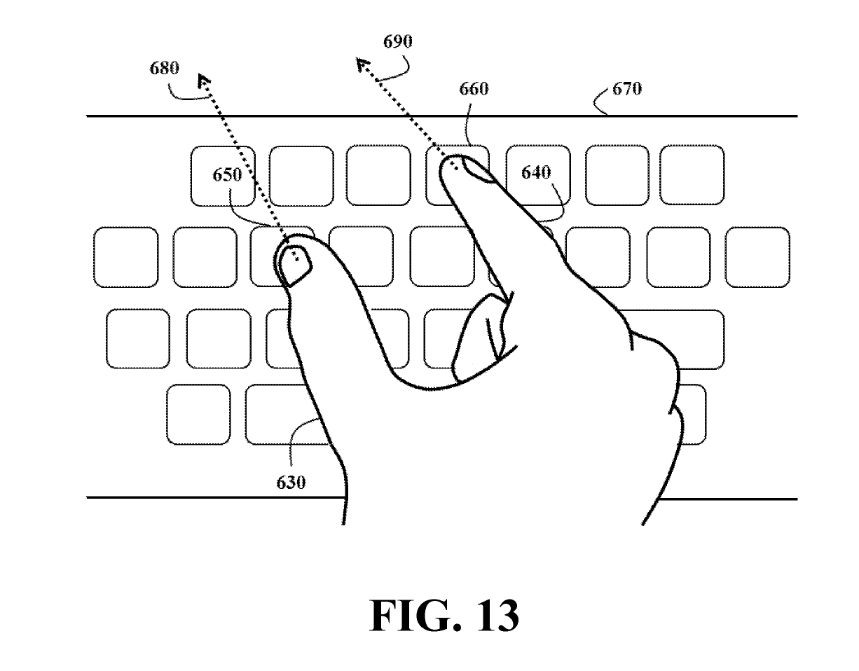

FIG. 12 illustrates the index finger 580 and the middle finger 590 of the right hand simultaneously touching the left button 600 and the right button 610 of a computer mouse 620. The two fingers apply two forces to the left and right buttons, in two 3D directions, to provide the computer system with an immediate input activating a predefined command. FIG. 13 illustrates the thumb 630 and the index finger 640 simultaneously touching two keys 650 and 660 of a computer keyboard 670. The two arrows 680 and 690 represent the 3D directions of the two forces applied by the fingers on the keys to provide the computer system with an immediate input activating a predefined action or command.

As shown in the previous examples, the 3D multi-touch can be generated by multiple fingers. However, the same results achieved by the 3D multi-touch of multiple fingers can be achieved by a single finger. Generally, in another embodiment, the present invention discloses a method for 3D touch comprising: applying a single touch force to a surface wherein the single touch force can be non-parallel and non-orthogonal to the surface plane; determining the three-dimensional direction and the magnitude of the single touch force; and interpreting each unique combination of a three-dimensional direction and a magnitude of the single touch force as a unique input to be provided to a computer system.

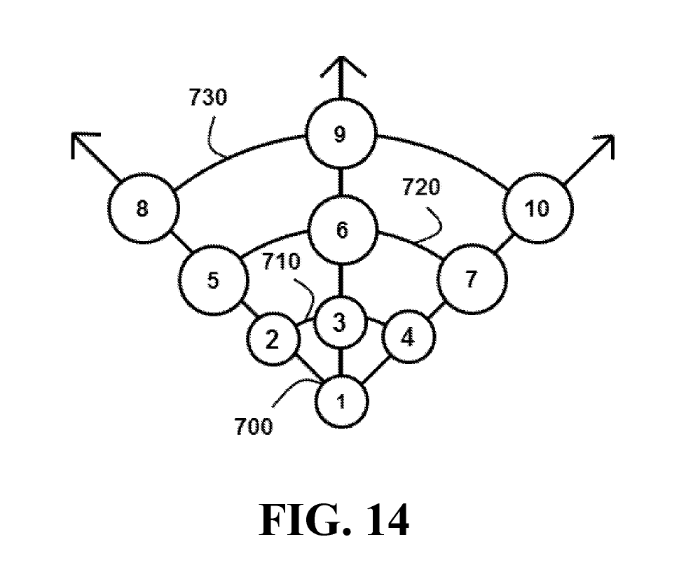

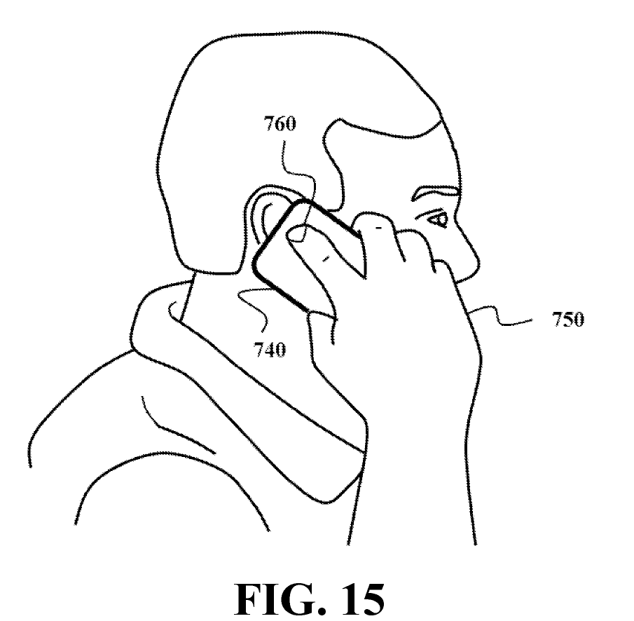

To clarify the concept of the aforementioned method, FIG. 14 illustrates ten imaginary spots represented by ten circles 1-10 accessible to the touch of a finger. The ten spots are positioned in four radial layers 700-740 relative to the finger to flow its position. The default position of the finger is assumed to be above spot #1, applying an orthogonal force on this spot. Accordingly, each touch of the finger to one of the ten imaginary spots applies a force in a different 3D direction. Detecting the 3D direction of the force determines which spot the user intends to target with his/her touch. This way, there is no need to present the ten imaginary spots on the touchscreen the user is using, where each different 3D direction of a finger force represents a different imaginary spot. Of course the number imaginary spots can vary according to the user's needs, and the available touch surface area. Using this method replaces the need of the GUI and the need to look at a screen while providing an input to a computer system.

For example, the ten imaginary spots enable a user to type using a single finger without having to look at the finger while typing. This is achieved by touching each spot of the ten imaginary spots with three forces, each of which has the same 3D direction and a different magnitude. In this case, the ten spots can provide 30 unique inputs to a computer system when using a single finger. The thirty inputs can represent the 26 English letters, in addition to, other main commands that are needed for typing, such as “delete”, “new line” “space” and “save”. If the three magnitudes of the finger force become four magnitudes, the ten spots can represent 40 unique inputs. If two fingers are used instead of a single finger, and each finger has its own ten spots, then the number of the unique inputs is doubled to 80.

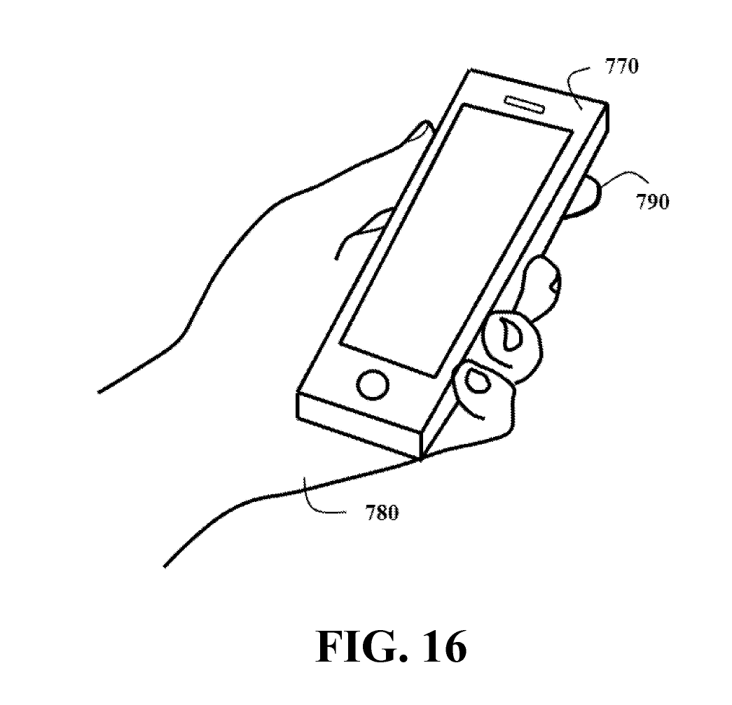

Of course, in addition to fast typing, the unique inputs provided by the imaginary spots can activate predefined commands or actions, similar to the actions indicated in the table of FIG. 8. For example, FIG. 15 illustrates a user talking on a mobile phone 740 while holding the mobile phone with a hand 750. The index finger 760 is touching the back of the mobile phone to select one of the ten imaginary spots that are assumed to be located on the back of the mobile phone. In this case, the user can type or provide different inputs associated with predefined commands, without needing to move the mobile phone away from his/her ear to look at the mobile phone screen. FIG. 16 illustrates a user holding a mobile phone 770 by a hand 780 while a finger 790 of the same hand touches the ten imaginary spots located on the back of the mobile phone. In this case, the user can type or provide inputs using the back of the mobile phone without obstructing the viewing of the mobile phone screen with a finger.

The ten imaginary spots can be located on the mobile phone screen, should the user prefer. Some imaginary spots can also be located on the side of the mobile phone to provide easy accessibility with the thumb of FIG. 16. In this case, due to the limited touch area available on the mobile phone side, only four imaginary sports are used. These four imaginary sports could be the spots No. 1, 3, 6, and 9 of the ten imaginary spots of FIG. 14. Applying a force with the same 3D direction, but with different magnitudes, to each one of the four spots makes the four spot provide 12 or 16 unique inputs. This way, the user has the choice to use the back, front, or sides of the mobile phone, or to use two of them simultaneously or successively, as it suits them.

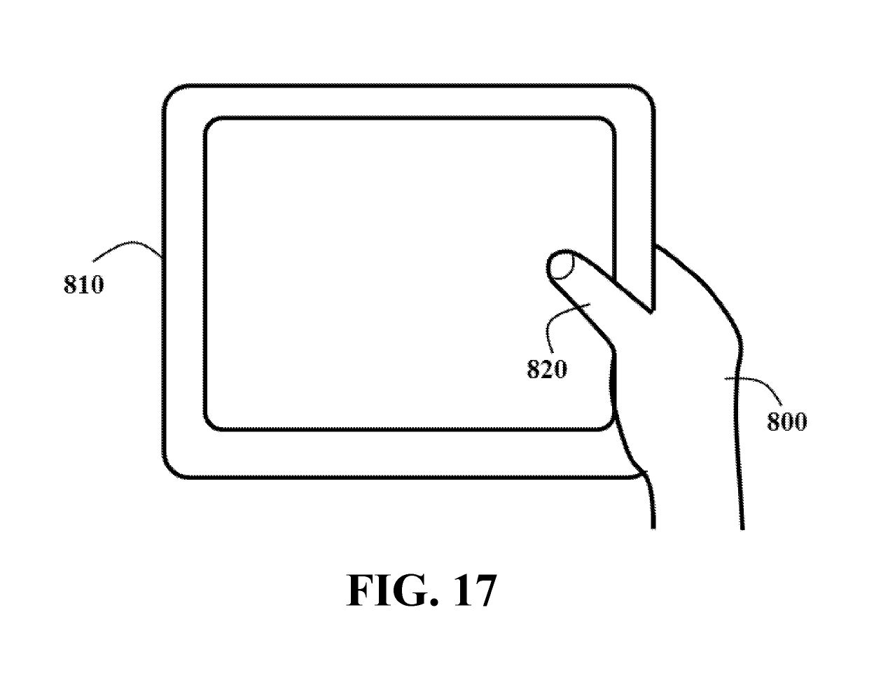

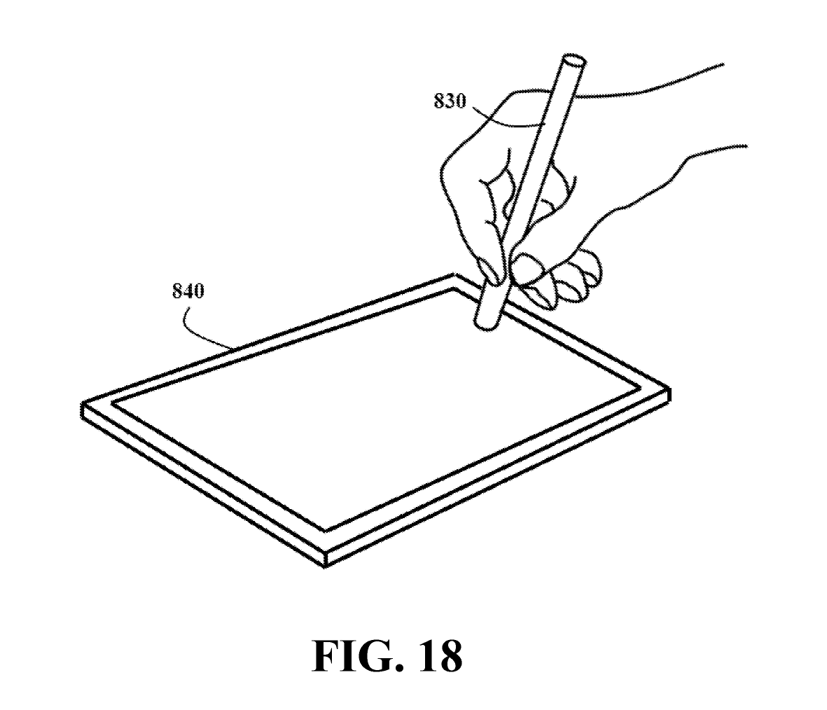

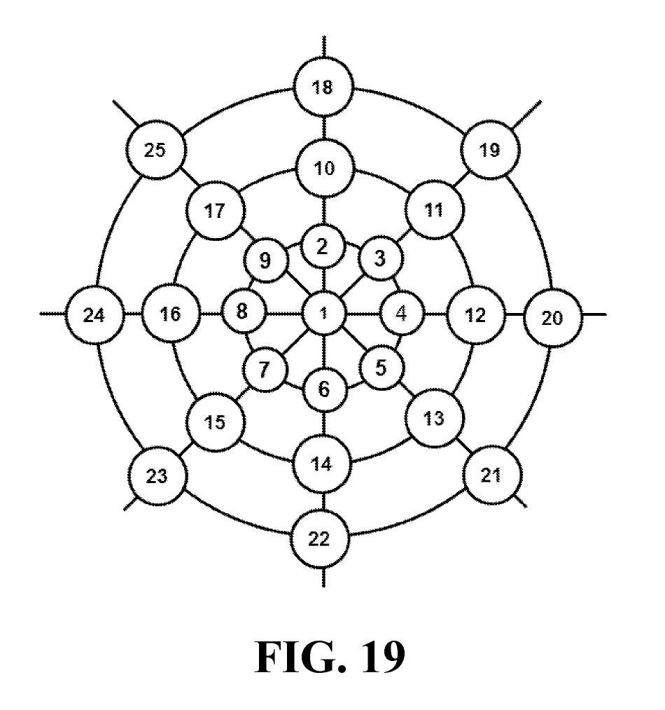

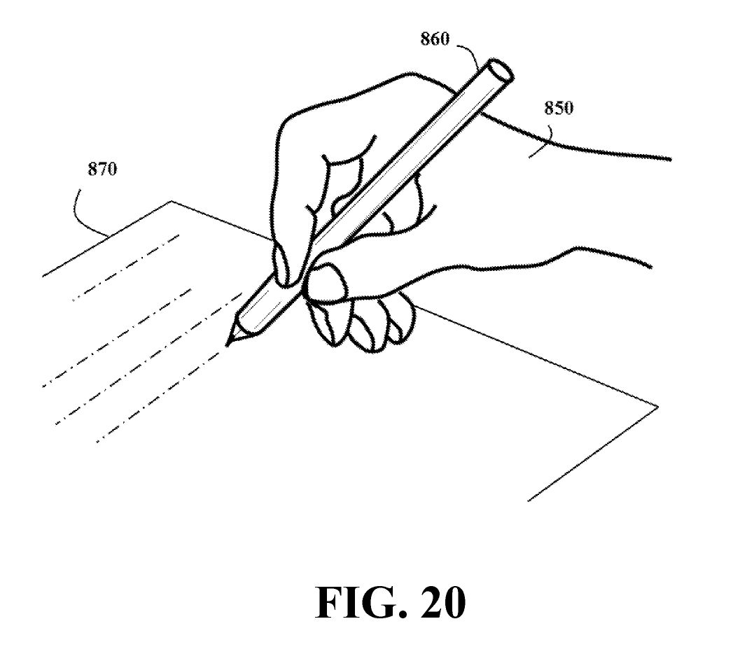

FIG. 17 illustrates a user's hand 800 holding a tablet 810 where a finger 820 of the same hand touches one of the ten imaginary sports located on the tablet screen. In this scenario, the user can hold and interact with the tablet using a single hand. FIG. 18 illustrates a user utilizing a stylus tool 830 to touch one of ten imaginary spots located on the tablet screen 840. In this case, the ten spots can be 25 spots, as illustrated in FIG. 19, where the stylus tilting in 3D has more directions or options than a user's finger. FIG. 20 illustrates a user's hand 850 writing with a pen 860 on a piece of paper 870 while using the 25 imaginary sports of FIG. 19. The pen provides an immediate input to a computer system representing its 3D direction, using a wireless 3D force sensor, as will be described subsequently.

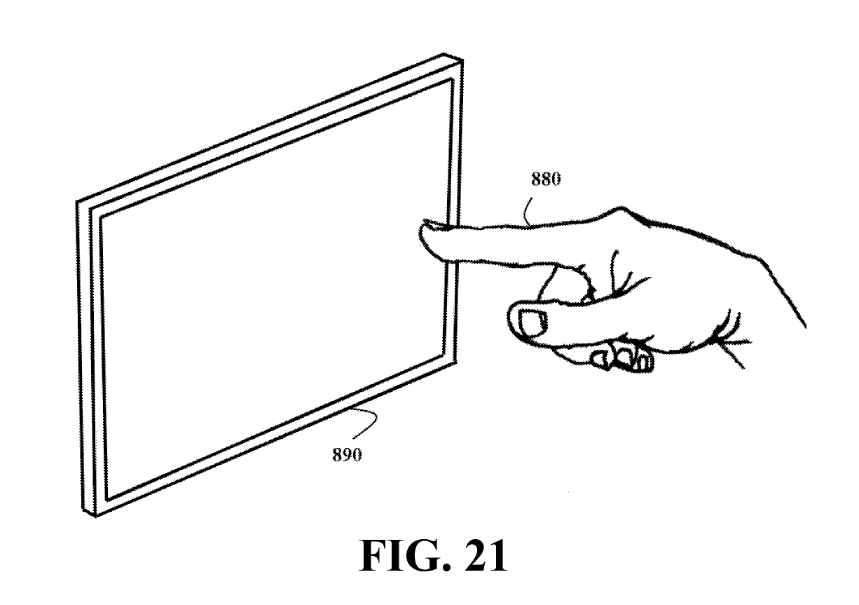

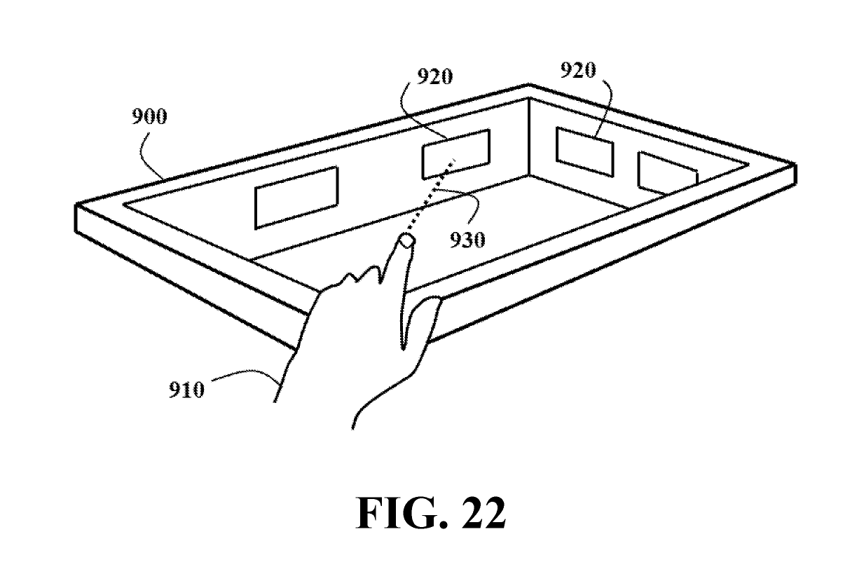

FIG. 21 illustrates a single finger 880 touching a touchscreen 890 of a GPS or a car Radio to select one of 25 imaginary sports located on the touchscreen. In this case, the user does not need to look at the touchscreen while s/he is driving the car, where s/he can type and interact with the electronic devices without moving his/her eyes from the road which enhances the user's safety. FIG. 22 illustrates a user interacting with a tablet 900 using a finger 910, to select one of the virtual objects 920 that are presented in a virtual 3D environment on the tablet screen. The dotted line 930 represents the 3D direction of the force applied by the user's finger on the tablet touchscreen. In this case, the virtual sports are not used. Instead, the 3D direction of the touch force is utilized to select or move objects in 3D on the tablet screen.

As can be noticed in all previous examples, the force applied to the touchscreen is non-parallel to the touchscreen plane. However, the same technique of the present invention can be utilized when the touch force is parallel to the touch surface. In one embodiment, the present invention discloses a method for 3D multi-touch comprising: applying multi-touch forces to a surface wherein the multi-touch forces are parallel to the surface plane; determining the direction of each force of the multi-touch forces; and interpreting each unique combination of directions of the multi-touch forces as a unique input to be provided to a computer system.

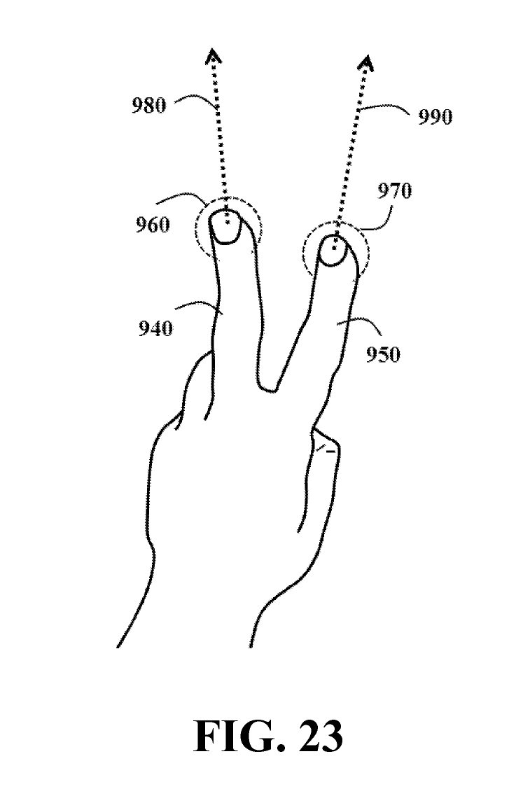

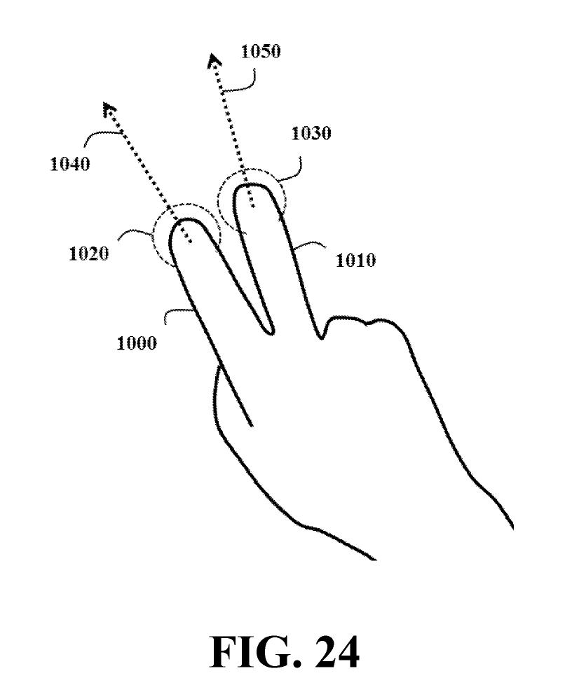

For example, FIG. 23 illustrates two fingers 940 and 950 of the left hand, touching a surface at two points 960 and 970, to apply two forces parallel to the surface plane. The two arrows 980 and 990 represent the direction of each one of the two forces relative to the x-axis of the surface plane. FIG. 24 illustrates two fingers 1000 and 1010 of the right hand touching a surface at two points 1020 and 1030, to apply two forces parallel to the surface plane. The two arrows 1040 and 1050 represent the direction of each one of the two forces relative to the x-axis of the surface plane. It is obvious in these two examples that the distance between the two fingers impacts the directions of the forces applied by the fingers to the touch surface. In other words, increasing or decreasing the angle between the fingers of the same hand changes the directions of the fingers relative to the x-axis. In the case of using two fingers of two hands, the user has more control over changing the angles between the fingers.

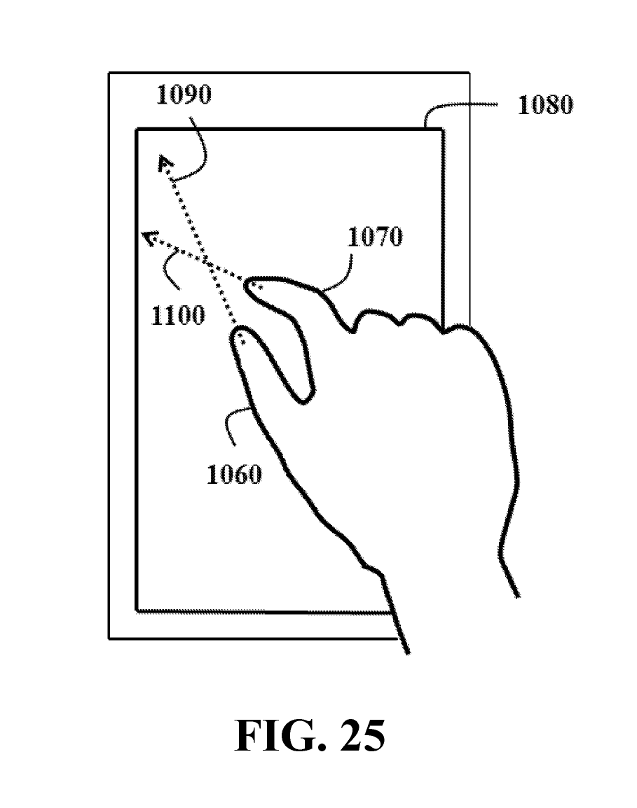

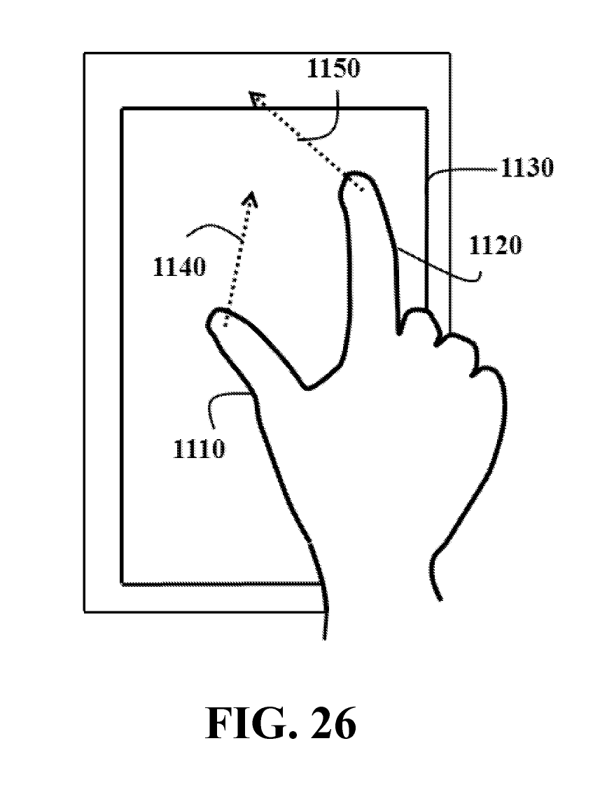

FIG. 25 illustrates two fingers 1060 and 1070, simultaneously applying two forces parallel to the plane of a mobile phone touchscreen 1080. The directions of the two forces are represented by two arrows 1090 and 1100, where the extension of the two arrows can intersect with each other. FIG. 26 illustrates two fingers 1110 and 1120, simultaneously applying two forces parallel to the plane of a mobile phone screen 1130. The directions of the two forces are represented by two arrows 1140 and 1150. As shown in the figure, the directions of the two arrows do not match the directions of the two fingers which is normal when a pressure is exerted by a finger in a different direction than the finger direction.

According to the previous description, there are two main types of the 3D multi-touch disclosed in the present invention. The first type is when the touch force is non-parallel to the touch surface, regardless the touch force is generated by a single finger or multiple fingers. The second type is when the touch force is parallel to the touch surface. However, there is a third type of 3D multi-touch that combines the non-parallel force and the parallel touch force to provide the computer system with one immediate input. This is achieved by simultaneously touching a touch surface with a first group of fingers and a second group of fingers. The first group of fingers includes one or more fingers applying non-parallel forces to the touch surface. The second group of fingers includes one or more fingers applying parallel forces to the touch surface.

In other words, in another embodiment, the present invention discloses a method for 3D multi-touch comprising: applying multi-touch forces to a surface wherein one or more forces of the multi-touch forces are non-parallel to the surface plane and the other forces of the multi-touch forces are parallel to the surface plane; determining the direction of each force of the multi-touch forces; and interpreting each unique combination of directions as a unique input to be provided to a computer system.

For example, a first finger may apply a first force that is orthogonal to a touchscreen, while a second finger simultaneously applies a second force that is parallel to the touchscreen. Also, a first finger may apply a first force that is non-orthogonally and non-parallel to a touchscreen, while simultaneously, a second finger applies a second force that is parallel to the touchscreen. Each unique combination of a 3D direction of the first force and a 2D direction of the second force represents one unique input to be provided to a computer system. Accordingly, in FIG. 9 the first finger 430 of the left hand 440 is applying an orthogonal force to the touchscreen, while the second finger 450 of the right hand 460 is simultaneously applying a parallel force to the touchscreen. In this case, each unique combination of directions of the two forces can be associated with a unique ID representing a unique input to be provided to a computer system, as was described subsequently. This method increases the number of the unique inputs that can be provided to the computer system without the user having to memorize a large number of fingers directions.

Overall, the present invention utilizes three main parameters to describe the touch of a user's hand to a touch surface. The first parameter is the number of the fingers that are simultaneously touching the touch surface. The second parameter is the 3D direction of the force applied by each finger on the touch surface. The third parameter is the magnitude of each force. However, there are other parameters that can be utilized to describe the touch of a user's hand to a touch surface. For example, a fourth parameter can be the distances between the fingers that are simultaneously touching the touch surface. A fifth parameter can be the time period that the fingers keep touching the touch surface with the same 3D directions. A sixth parameter can be the movement of the fingers on the touch surface while keeping the same 3D directions of the forces. A seventh parameter can be the area of each finger that touches the touch surface. An eighth parameter can be the zones or parts of the touch surface that are touched by the fingers. For example, if the touch surface is a touch screen, then the area of the touchscreen could be divided into zones. If the touch surface is a mobile phone, the parts of the mobile phone could be its front, back and sides, as was described previously.

The main advantages of the present invention is utilizing existing hardware technologies in a simplifies and straightforward manner which easily and inexpensively carry out the present 3D multi-touch. For example, the 3D direction of a force applied by a finger on a touch pad can be determined by using the technology disclosed in the U.S. patent application Ser. No. 14/157,499, titled “Three-dimensional Touchscreen”. The magnitude of a force applied by a finger on a touch surface can be determined by using the technology disclosed in the U.S. patent application Ser. No. 14/169,822, titled “Force Sensing Touchscreen”. The 3D direction of a force applied by a finger to a button of a computer mouse, a key of a computer keyboard can be determined by using the technology disclosed in the U.S. patent application Ser. No. 14/147,528, titled “Biometrics Touchscreen”.

The 3D direction of a force applied by a finger to one side of the six sides of a mobile phone or tablet can be achieved by using the technology disclosed in the U.S. patent application Ser. No. 12/587,339, titled “Touch Sensing Technology”. The 3D direction of a force applied by a stylus or pen on a touch surface can be determined by using the technology disclosed in the U.S. patent application Ser. No. 14/179,430, titled “3D Force Sensor For Internet Of Things”. This is in addition to other innovative applications that can created by combining the present invention and the technologies disclosed in the U.S. patent application Ser. No. 14/146,008, titled “Computer Input Device For Handheld Devices”, and Ser. No. 14/149,807, titled “Remote Sensing Touchscreen”. The seven aforementioned patent applications are assigned to the same assignee of the present patent applications.

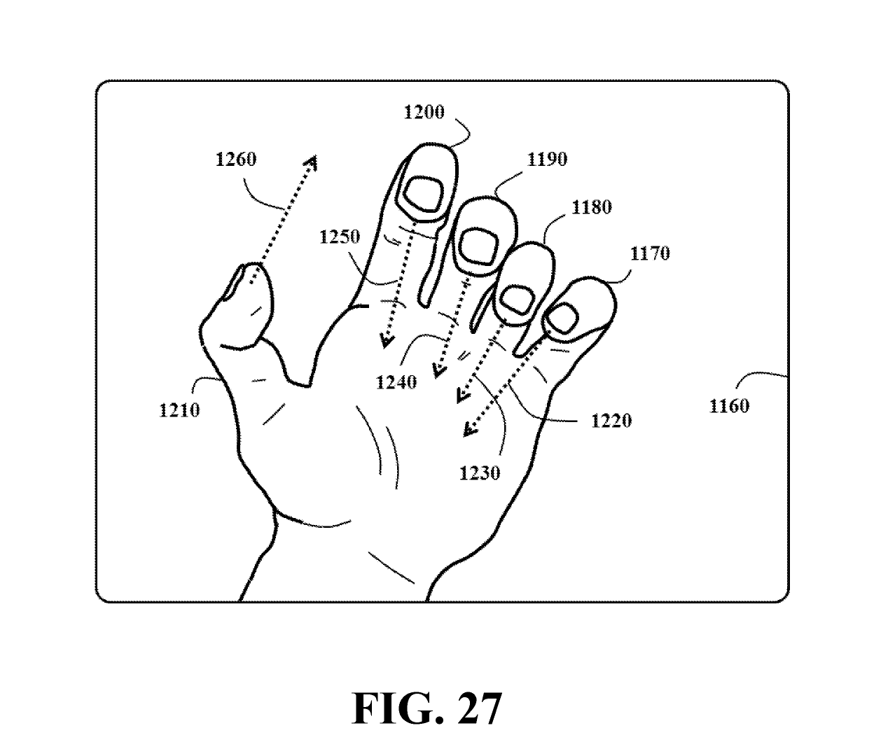

Some technologies already commercially available in the market and can be used to carry out the present invention of 3D multi-touch. For example, a depth sensing camera can detect the distance of each point of a hand relative to a computer display. Detecting the distances between the hand points and the computer display can create a 3D model of the hand to determine the 3D direction of each finger. Using a regular camera to capture the pictures of the hand in front of a computer display can also be used to determine the 3D direction of each finger. For example, FIG. 27 illustrates a picture 1160 of a hand 1170, showing the five hand fingers 1180. Analyzing the given picture using a computer vision program, as known in the art, can determine the five 3D directions 1190 of the five fingers. Also, a modern 3D touchpad that remotely detects the position of the fingers relative to the 3D touchpad surface can be used to carry out the method of the present invention of the 3D multi-touch.

Conclusively, while a number of exemplary embodiments have been presented in the description of the present invention, it should be understood that a vast number of variations exist, and these exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below. Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A computer input method comprising; applying multi-touch forces to a surface wherein the multi-touch forces can be non-parallel and non-orthogonal to the surface plane;
determining the three-dimensional direction of each force of the multi-touch forces; and
interpreting each unique combination of three-dimensional directions as a unique input to be provided to a computer system.

2. The method of claim 1 wherein the surface is a surface of a mobile phone, tablet, computer, or an electronic device, or a button on a computer mouse, or a key of a computer keyboard.

3. The method of claim 1 wherein the three-dimensional direction is represented by a first angle located between a line representing the three-dimensional direction and the surface, and a second angle located between the projection of the line on the surface and the x-axis of the surface plane.

4. The method of claim 1 wherein each unique input activates a predefined command or action to be performed on the computer display.

5. The method of claim 1 further the unique combination is associated with data representing the distances between the multi-touch forces, the time period of applying the multi-touch forces, the movement of the multi-touch forces, or the parts of the surface that are touched by the multi-touch forces.

6. The method of claim 1 further the multi-touch forces are represented by multiple objects located at different distances from an imaginary surface wherein the distance between each object of the multiple objects and the imaginary surface represents a three-dimensional direction of a force of the multi-touch forces.

7. The method of claim 1 wherein one or more forces of the multi-touch forces are non-parallel to the surface plane; and one or more forces of the multi-touch forces are parallel to the surface plane.

8. A computer input method comprising; applying a single touch force to a surface wherein the single touch force can be non-parallel and non-orthogonal to the surface plane; determining the three-dimensional direction of the single touch force; and interpreting each unique three-dimensional direction as a unique input to be provided to a computer system.

9. The method of claim 8 further determining the magnitude of the single touch force, and interpreting each unique combination of a three-dimensional direction and a magnitude as a unique input to be provided to a computer system.

10. The method of claim 8 wherein the three-dimensional direction is represented by a first angle located between a line representing the three-dimensional direction and the surface, and a second angle located between the projection of the line on the surface and the x-axis of the surface plane.

11. The method of claim 8 wherein each unique three dimensional direction is interpreted as a selection of a certain imaginary spot representing a certain key of a virtual keyboard.

12. The method of claim 8 wherein the single touch force is applied to the surface by a finger, stylus tool, or pen.

13. The method of claim 8 further the unique input is associated with data representing the time period of applying the single touch force, the movement of the single touch force, or the part of the surface that is touched by the single touch force.

14. The method of claim 8 further the single touch force is represented by an object located at a distance from an imaginary surface wherein the distance represents the three-dimensional direction of the single touch force.

15. A computer input method comprising; applying multi-touch forces to a surface wherein the multi-touch forces are parallel to the surface plane; determining the direction of each force of the multi-touch forces; and interpreting each unique combination of directions of the multi-touch forces as a unique input to be provided to a computer system.

16. The method of claim 15 wherein the direction of each force is represented by an angle located between a line representing the force and the x-axis of the surface plane.

17. The method of claim 15 wherein the surface is a surface of a mobile phone, tablet, computer, or an electronic device, or a button on a computer mouse, or a key of a computer keyboard.

18. The method of claim 15 wherein each unique input activates a predefined command or action to be performed on the computer display

19. The method of claim 15 further determining the magnitude of the multi-touch forces, and interpreting each unique combination of directions and a magnitude as a unique input to be provided to a computer system.

20. The method of claim 15 further the unique combination is associated with data representing the distances between the multi-touch forces, the time period of applying the multi-touch forces, the movement of the multi-touch forces, or the parts of the surface that are touched by the multi-touch forces.
